(19) United States
(12) Patent Application Publication
(10) Pub. No.: US 2015/0257156 A1
(43) Pub. Date: Sep. 10, 2015

(54) DYNAMIC RADIO FREQUENCY MAPPING

(71) Applicant: The Arizona Board of Regents on Behalf of the University of Arizona, Tucson, AZ (US)

(72) Inventors: Tamal Bose, Tucson, AZ (US); Haris Volos, Tucson, AZ (US); Garrett Vanhoy, Tucson, AZ (US); Mohammed Hirzallah, Tucson, AZ (US); Carlos Bastidas, Tucson, AZ (US)

(21) Appl. No.: 14/643,789

(22) Filed: Mar. 10, 2015

Related U.S. Application Data
(60) Provisional application No. 61/950,805, filed on Mar. 10, 2014.

(51) Int. Cl. H04W 72/04; H04W 72/08

(52) U.S. Cl. CPC H04W 72/0453; H04W 72/085

(57) ABSTRACT

An intelligent cognitive radio system is disclosed that acquires information about its environment to make operational decisions. Dynamic radio frequency mapping provides estimates of RF power levels over an area where spectrum activity or changes in the environment may be transient. These power levels can be used for a variety of applications such as interference management, spectrum policing, and facilitating spectrum auctions. The RF mapping can be accomplished by a network of sensors that are distributed in a geographical area and used to spatially sample signal levels. The present invention can quantify the effect of aliasing on the estimation of an RF map as a function of the sampling density and the number of antennas used at the sensing node.

### CROSS-REFERENCE TO RELATED APPLICATIONS

The present application claims the priority benefit of U.S. provisional application No. 61/950,805 filed Mar. 10, 2014 and entitled “Dynamic Radio Frequency Mapping System,” the disclosure of which is incorporated herein by reference.

### BACKGROUND OF THE INVENTION

1. Field of the Invention

The present invention generally relates to radio frequency (RF) power levels in a geographical area. More specifically, the present invention relates to dynamic RF mapping to estimate RF signal power in areas where the physical environment or spectral activity rapidly evolves.

2. Description of the Related Art

The estimation of RF power levels in a geographical area is necessary for the planning and management of wireless networks. Current methods to map RF power levels involve extensive modeling and data collection throughout an area to be mapped. Due to the extensiveness of these modeling and data collection methodologies, they are relatively slow and expensive.

Existing mapping methodologies also focus on identifying estimation techniques. There is minimal (and sometimes no) consideration on the sampling requirements and corresponding error in these techniques. As such, there is not an adequate explanation as to the origin of any estimation error.

For example, if an RF map is viewed as a two-dimensional signal, any estimation error is no longer a by-product of having but a few sample points. Any such error can instead be described in detail as aliasing error, which may be addressed by first band-limiting the signal through an anti-aliasing filter and then sampling the signal. But because an RF map cannot be separated from its samples to introduce an anti-aliasing filter, filtering the entire RF map is not necessarily an option.

A further challenge to existing mapping techniques is that the Nyquist sampling rate in most cases (e.g., small-scale fading for signals with a center frequency in the order of GHz) will result in an arbitrarily large number of required sampling points. Such a number of points is practically impossible to implement. To satisfy the Nyquist sampling rate, the distance between each two sample points must be on the same order as the maximum spatial variation of the phenomena that may be active. This translates to the sampling distance being in the range of meters to centimeters depending on the operating frequency. Because sensors cannot be deployed in the order of centimeters, estimation errors due to aliasing are unavoidable.

There is a need in the art to resolve the effect of Rayleigh fading on estimation error. There is a further need in the art for practical anti-aliasing solutions in DRFM. There is a still further need for a balanced tradeoff in DRFM sensor design in the presence of Rayleigh fading.

### SUMMARY OF THE PRESENTLY CLAIMED INVENTION

A system for dynamic RF mapping is claimed.

### BRIEF DESCRIPTION OF THE DRAWINGS

FIG. 1 illustrates a sensor network for mapping a geographical area to facilitate spectrum management and brokerage.

FIG. 2 illustrates an RF map and sampling points in a geographical area.

FIG. 3 illustrates a percent of coefficients that contain bandwidth.

FIG. 4 illustrates global and local sampling points.

FIG. 5 illustrates antenna spacing.

FIG. 6 illustrates sampling points versus estimation error.

FIG. 7 illustrates a system for facilitating spectrum management and brokerage as might be implemented in a sensor network like that described in the context of FIG. 1.

FIG. 8 is a method for implementing dynamic RF mapping.

### DETAILED DESCRIPTION

Embodiments of the present invention provide for a dynamic radio frequency mapping system that facilitates spectrum management and brokerage over a geographic area. The system is based on a network of spectrum sensing nodes that are distributed over a geographic area to be mapped. From information provided by the sensing nodes (sampling points), an RF activity map is generated.

The generated RF map contains information about the RF power levels in frequencies of interest over the geographical area. The RF map may also contain other information about the transmitters, including type of signal, specific transmitter identification, and operator. From observations of a current map, historical data from prior maps, and information concerning other major activity in a geographic area (e.g., earthquakes, sporting events, and trade fairs), the future RF activity for that area can be forecast. Using RF activity forecasts and indicia of current RF activity, future spectrum needs can be estimated and unanticipated spectrum usage detected and mitigated.

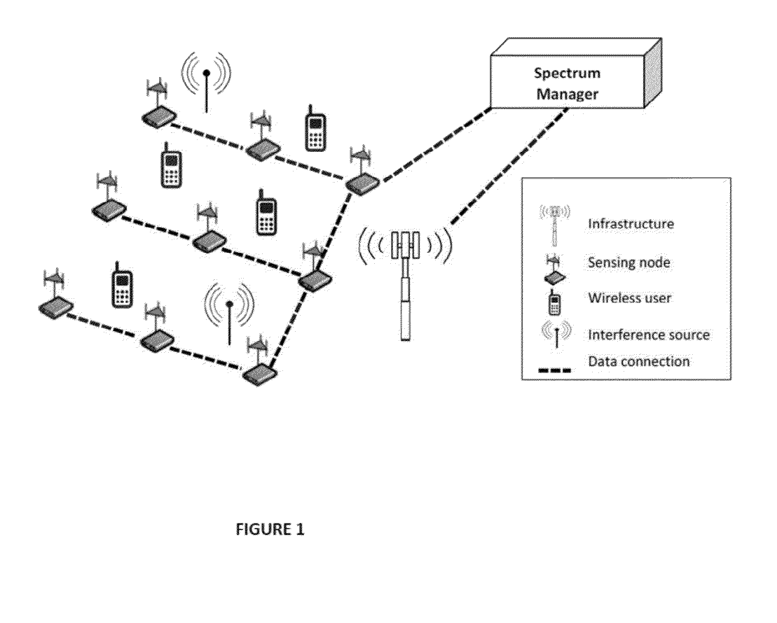

FIG. 1 illustrates a sensor network 100 for mapping a geographical area to facilitate spectrum management and brokerage. The sensor network 100 of FIG. 1, illustrates nine sensing nodes (110A, 110B . . . 1100. The nodes 110 in FIG. 1 may be low-end spectrum sensing nodes or higher-end software-defined-radio (SDR) platforms. The sensor network 100 may be a homogeneous or heterogeneous combination of sensing nodes 110 (i.e., all low-end nodes, all SDRS, or a combination of the two).

FIG. 1 further illustrates radio network infrastructure 120. Radio network infrastructure 120 is inclusive of the universe of equipment necessary to access the RF spectrum. An example of such infrastructure includes base station equipment. Base station equipment is further inclusive of receivers, transmitters, and/or transceivers, encoders and decoders, and a power supply. Antenna and tower equipment may also be a part of a base station implementation. Network infrastructure 120 may further include a network of repeaters or other transmission/retransmission towers as well as any variety of wireless access devices that might be present in a particular network or cell of a network.

FIG. 1 further illustrates a series of wireless users 130, interference sources 140, and data connections 150. Wireless users 130 are representative of any wireless device having a radio and that may access a wireless network, including by way of network infrastructure 120. Examples of wireless devices include traditional two-way radios, smartphones, tablets, or other mobile devices with cellular or wireless radios, wireless laptops, and wireless network devices such as wireless routers.

Interference sources 140 are generally viewed as any external source that causes or contributes to electromagnetic interference. Such interference disturbs or otherwise affects an electrical circuit (e.g., a radio) thereby degrading or limiting the effective performance of that circuit. Effects can span a range that includes a degradation of data, a total loss of data, as well as a total lack of network access. Common interference sources 140 include GPS units, garage door openers, Bluetooth devices, and cordless phones. In some instances, too many wireless users 130 in a particular geographic area that are attempting to access a particular wireless frequency or channel can themselves constitute an interference source 140.

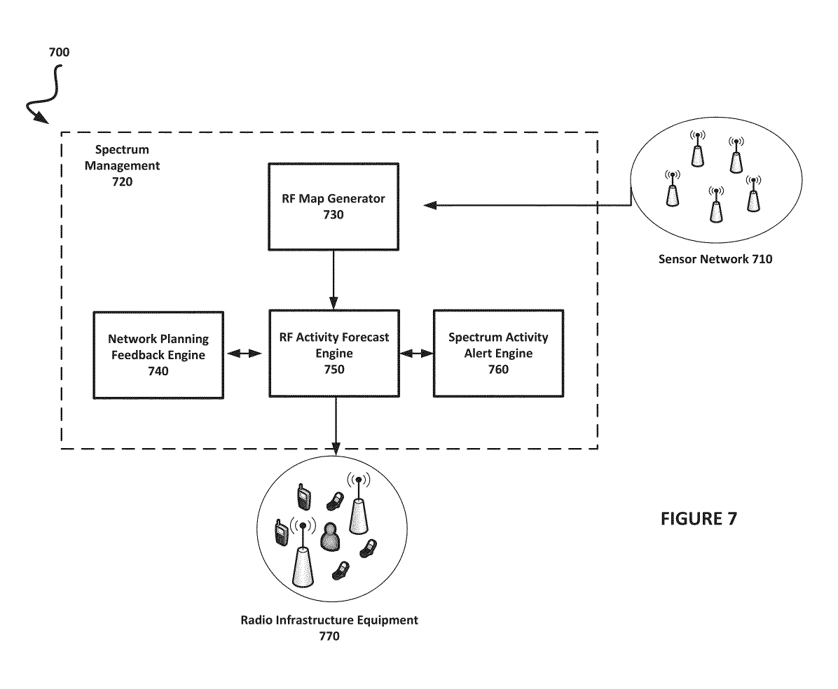

Data connections 150 are the wireless and/or wired connections that communicatively couple wireless users 130 with network infrastructure 120, various components of network infrastructure 120 with other infrastructure componentry, and sensing nodes to dynamic RF mapping manager 160. Dynamic RF mapping manager 160 includes the hardware, logic, and network connectivity to allow for communication with other components of network 100, including but not limited to sensing nodes 110. Manager 160 performs dynamic RF mapping in light of information received from such nodes 110. Manager 160 also generates network planning feedback, performs RF activity forecasting, and provides spectrum activity alerts in light of dynamic RF mapping as further discussed in the context of FIG. 7 (720).

The RF activity sampled, measured, or otherwise sensed by the network 100 of FIG. 1 may be related to a particular channel or sub-carrier of the RF spectrum. Data measurements may also be inclusive of certain types of information that might be considered relevant to new or potential additional users of a segment of the spectrum, especially with respect to estimating future spectrum needs or detecting unanticipated spectrum usage and proactively mitigating the same. A profiling application programming interface (API) and signal processing algorithms executing at manager 160 generate an RF map of the RF activity using the sensors 110 deployed in the geographic area of network 100.

The collection, processing, and mapping of spectrum sensing data from sets of networked spectrum sensors provides for a robust characterization of a wireless service area. Such a characterization provides greater potential to make better use of scarce spectrum resources. The aforementioned RF map, too, can be used to provide historical channel condition data, signal-to-noise ratio data, and other information to other entities that will find this information valuable to make better informed decisions on their use and/or management of spectrum resources.

By deploying dynamic RF Mapping (DRFM) in a network 100 like that illustrated in FIG. 1, an estimation of the RF signal power in an area where the physical environment or spectral activity rapidly evolves may be derived. The results of DRFM may be utilized to facilitate any number of RF-related applications and services. For example, the results of DRFM mapping may be used in conjunction with dynamic spectrum access, spectrum management, policy enforcement, and usage analytics as well as in the context of military applications.

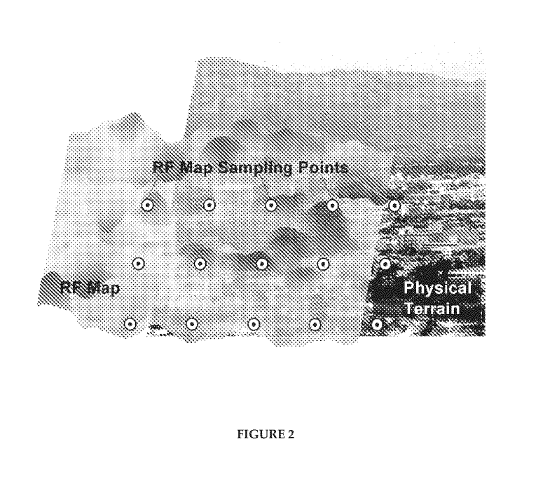

FIG. 2 illustrates an RF map 210 and sampling points 220 in a geographical area 230. The sampling points 220 of FIG. 2 can be instantiated as sensors through the geographical area 230. Sensors may be akin to those described in the context of the sensing nodes 110 of FIG. 1. Embodiments of the present invention approach DRFM from a digital signal processing (DSP) perspective. Such an approach differs from prior art estimation techniques that failed to properly consider sampling requirements and resulting errors. Through the use of a DSP perspective, the origin of estimation errors can be adequately explained through various engineering principles. More specifically, overcoming estimation errors due to small-scale fading should not occur through incorporation of additional sensors. Overcoming such errors should instead occur by estimating the RF map 210 without small-scale fading by combining two or more closely spaced samples to estimates the local average power at a larger spatial scale. Even when samples are correlated, with enough samples, the local spatial average can be attained with reasonable accuracy.

Analysis and quantification of the estimation error that arises as a result of small-scale fading may generally be described throughout as aliasing error. While the nature of this effect depends on a given propagation model, the following log-normal path-loss shadow model using Rayleigh fading is illustrative:

$$PL ( d ) [ dB ] = \overline{PL} ( {d}_{0} ) + 10 n {log}_{10} ( \frac{d}{{d}_{0}} ) + {X}_{σ}$$

where d is the TX-RX separation distance, and PL(d₀) is the average path loss for a reference distance d₀, n the path loss exponent, and Xσ a zero-mean Gaussian distributed random variable (in dB) with a standard deviation σ (in dB) that represents the effects of shadowing.

As an RF map is ideally estimated in decibels, the foregoing model is analyzed with small-scale fading using frequency domain analysis. An example of such analysis utilizes a closed-form expression for the power spectral density (PSD), which may be defined as:

Sₓₓ(ω)=∫_{-∞}^{∞}γ(τ)e^{iωτ}dτ

where γ is the autocorrelation function. And since shadow fading and Rayleigh fading are generated from random variables, their PSDs are best obtained utilizing the Wiener-Khinchin Theorem.

Use of the foregoing theorem allows extension of the closed-form expression of PSD to wide-sense stationary random processes. While the autocorrelation function of a random process with a Rayleigh distribution is well known, the autocorrelation function for the decibel-record of Rayleigh fading, also known as the anti-log Rayleigh distribution (ALR), may be represented through numerical analysis to make a general conclusion about the nature of aliasing.

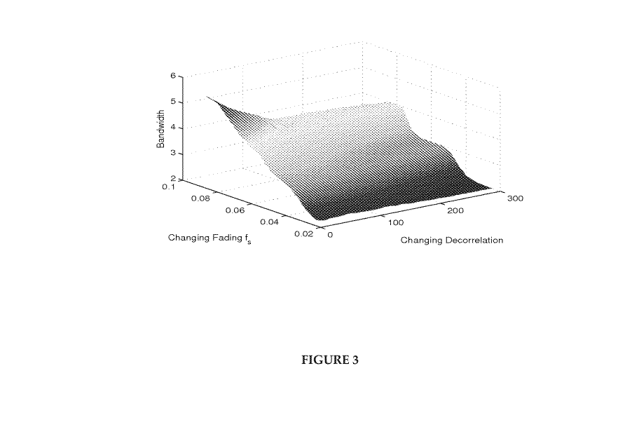

While the Rayleigh fading contribution to the overall PSD generally increases the bandwidth of the signal, it does not significantly contribute to higher frequencies. Using the following definition of signal bandwidth:

$${arg min}_{B} \frac{{\sum }_{k = 0}^{B / N} {X}_{k}^{2}}{{\sum }_{k = 0}^{N} {X}_{k}^{2}} > .98$$

where Xₖ denotes the K^{th} coefficient of the discrete cosine transform (DCT) and B/N is necessarily an integer, Doppler shift and the autocorrelation function of a shadow fading portion can be varied to result in the bandwidth recordation shown in FIG. 3.

What this suggests is that most of the signal energy is within the low-frequency components (i.e. path-loss and shadow fading) even with severe Rayleigh fading. Thus, the error due to aliasing comes from the remaining 2% of the energy that lies outside of the bandwidth. Capturing this remaining energy could require hundreds of times more samples to capture than to capture the main bandwidth. Additionally, there appear to regions where the bandwidth remains constant Doppler shift. This suggests that in some instances that Rayleigh fading may not be severe enough to have a noticeable effect on the bandwidth. Therefore, Rayleigh fading will not affect PSD absent the most severe cases.

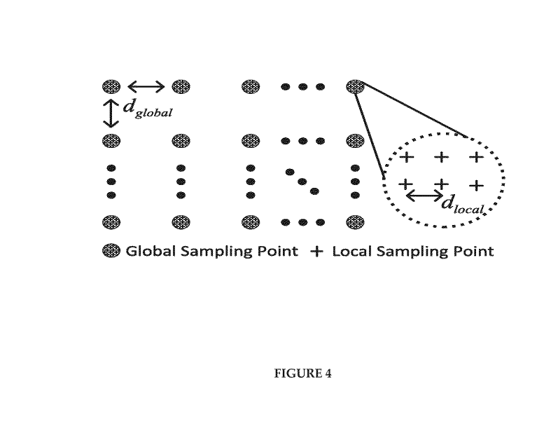

The proposed solution to mitigating the foregoing aliasing effect on an RF map is to use very closely spaced samples to estimate the local average power. These samples will be separated by some distance d_{local} that will determine a correlation between their measurements. When these measurements are combined, they create a single sampling point that will be used to estimate the RF map at a larger spatial scale; each of these points are separated by a distance d_{global}. This relationship is shown in FIG. 4.

Moving to a two-dimensional case, several realizations of an RF map are generated from which estimates are to be created. It is necessary to generate enough points for a given realization so that the points faithfully represent each phenomenon. This means that using the all the samples from the generated RF map, one should be able to reproduce a continuous RF map through interpolation without a significant error. Absent that, even when comparing against the generated RF map, estimation errors are against a band-limited version of an RF map and would not give insights about more realistic scenarios and thus generate misleading results.

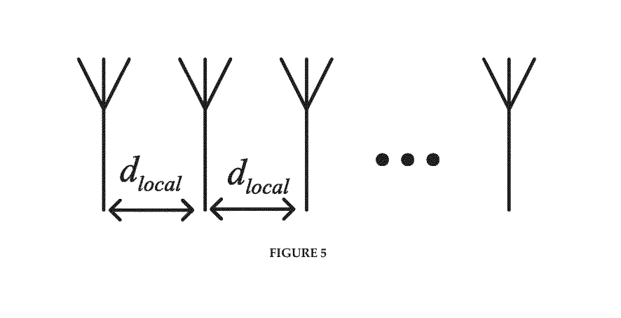

Given the power p due to the pathloss and shadowing, the received power r due to Rayleigh fading is given by:

$$r = \frac{{p}^{2}}{4} ( {X}^{2} + {Y}^{2} )$$

where X and Y are zero mean Gaussian random variables and including the effect of correlation between multiple closely-spaced samples will lead to a trade-off analysis between sample spacing and the number of samples for small-scale fading. This effectively corresponds to antenna separation and the number of antenna elements as shown in FIG. 5.

In the case of Rayleigh fading, the correlation between two measurements separated by a distance d are given by:

J₀(2πd/λ)

where J₀ is a zeroth-order Bessel function of the first kind and λ (m) is the wavelength of the received signal. Using this function, correlation matrix C may be created where Cᵢⱼ is the correlation between the i^{th} and j^{th} element. A vector may then be generated using Cholesky decomposition.

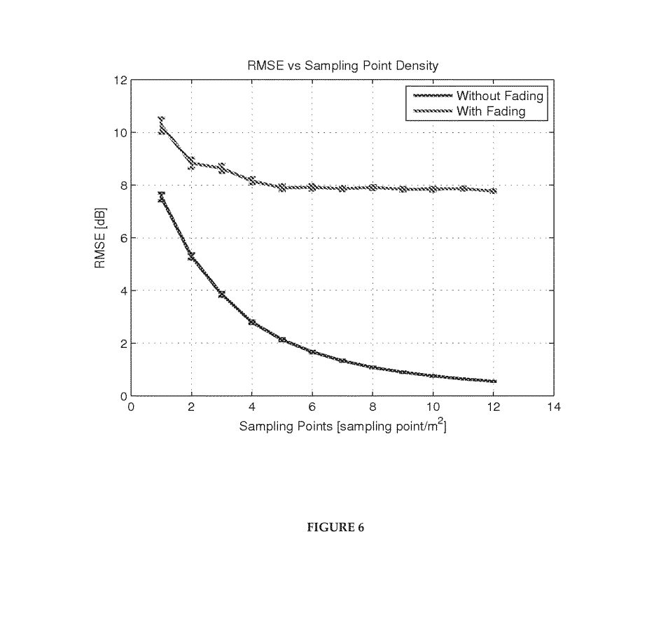

Using the generated RF maps, average estimation errors are obtained using the DCT interpolation method. To see the effect small-scale fading in estimating an RF map, the estimation error of a map is compared with and without small-scale fading. For each case, the number of sampling points is varied and the estimation error is recorded in terms of the point-wise average root mean square error (RMSE). This same metric is then used for all subsequent simulations, the results of which are illustrated in FIG. 6.

For a small number of sampling points, the effect of small-scale fading is negligible in terms of the error is adds. As the number of sampling points increases, however, the additional error increases even though the overall error may decrease. This reflects that the potential gain of mitigating effects of small-scale fading also depends on the number of sampling points.

To quantify the ability of using diversity to reduce aliasing effects, two estimates of a generated RF map are compared with and without Rayleigh fading. The difference between the errors of the two estimates and the RF map will indicate how effective applying diversity in RF Mapping will reduce the aliasing effect. Thus, the lower the RMSE values indicate that the estimated map is closer to the case without small-scale fading. Thus, the RMSE can be interpreted as the additional error due to the introduction of Rayleigh fading.

Reducing the maximum correlation and thus increasing the antenna separation distance will reduce the additional error. This relationship is not linear, however. For fewer points, this mitigation method is more effective at reducing the additional error from small-scale fading. This mitigation method works well for lower points because the overall error for lower points is already significant. Thus reducing the additional error due to fading is easier. Nevertheless, reducing the effect of small-scale fading can be done with a variety of different design options, some of which are illustrated here in Table I:

TABLE I
SAMPLING REQUIREMENTS FOR CERTAIN
RMSE VALUE IN THREE SCENARIOS

| Overall | No of Global | No of | Avg Antenna | |
|---|---|---|---|---|
| RMSE | Samples | Antenna | Distance (m) | Correlation |
| 3.5 | 2500 | 12 | ≧.765 | 0 |
| 4 | 100 | 7 | .649 | .2 |
| 5.687 | 16 | 4 | .426 | .6 |

These design options represent varying requirements on the overall RMSE. As evidenced by Table I, significantly more global samples and local samples are required to achieve even better accuracy in some case. For example, to decrease the RMSE from 4 to 3.5, requires 25 times more global samples, 5 more local samples per global sample, and a bigger separation distance. Leveraging the trade-off between the number of samples and accuracy may be subject to particular design or system requirements.

The foregoing describes a method to reduce the estimation error for DRFM. As described above, approaching DRFM from a digital signal processing perspective allows the estimation error to be viewed as error due to aliasing. For environments that have small-scale fading, the aliasing error cannot be practically reduced by effectively increasing the number of samples. Thus, estimating the local average power by taking very closely spaced samples and estimating the RF map without fading may be imposed. By taking as few as two or three samples, the estimation error due to small-scale fading can be reduced by several decibels. Additionally, in the case where samples are correlated because they are so closely spaced, a trade-off exists between the number of closely-space samples and their spacing to achieve the same desired level of accuracy.

FIG. 7 illustrates a system 700 for facilitating spectrum management and brokerage as might be implemented in a sensor network like that described in the context of FIG. 1. FIG. 7 includes spectrum sensor network 710, which correlates to the sensor network 110 of FIG. 1, and spectrum manager 720, which correlates to manager 160 of FIG. 1. Spectrum manager 720 includes RF map generator 730, network planning feedback engine 740, RF activity forecast engine 750, and spectrum activity alert engine 760. System 700 as illustrated in FIG. 7 also includes radio network infrastructure 770, which correlates to infrastructure 120 of FIG. 1.

Data collected from sensor network (710) is provided to RF map generator 730, which operates in conjunction with the spectrum manager 720. Spectrum manager 720 includes the necessary hardware such as database storage, memory, and processing capabilities to execute the logic to effectuate the various engines described herein. Spectrum manager 720 also includes the requisite network interfaces to engage with sensor network 710 and network infrastructure 770. These interfaces may include wired network connections as well as wireless connections such as antenna. Spectrum manager may be connected—either directly or intermediately—to network components such as base stations or other computing networks.

Data including sampling points, sampling point data, and sensor deployment patterns for a given geographical information are provided to RF map generator 730. Map generator executes one or more of the methodologies described above to generate an RF map as discussed in the context of FIG. 2. The output of RF map generator is then provided to one or more of network planning feedback engine 740, RF activity forecast engine 750, and spectrum activity alert engine 760, all of which are a part of spectrum manager 720. Each of the foregoing engines may also share information with one another.

Forecast engine 750 utilizes the predictable, bounded, and accurate data from map generator 730 in conjunction with historical measurements and correlation with major events in a geographical area to forecast future RF activity using anticipated use patterns. In some instances, seasonal considerations may be employed. Such considerations and other historical information may be maintained in a database accessible to manager 720.

Feedback engine 740 may combine forecast and current usage for network planning and/or spectrum management recommendations. This information may be used in wireless network planning or for spectrum management activities such as determining where more base stations are needed, where adjustments may be required to existing base stations, to identify opportunities for additional spectrum assignments, or to otherwise optimize spectrum use. In some instances, feedback engine may provide instructions to one or more components of infrastructure 770 to automatically implement the same. In other instances, data may be provided in the form of a report or recommendation for manual implementation by one or more network engineers or administrators.

Spectrum alert engine 760 uses current and forecasted activity for issuing spectrum use alerts when network usage deviates from the forecasted usage. The alert can be utilized to police the spectrum, to enforce one or more spectrum use policies, to detect malicious activity, and to help plan for future usage when current predictions are found to be inadequate under legitimate unanticipated use.

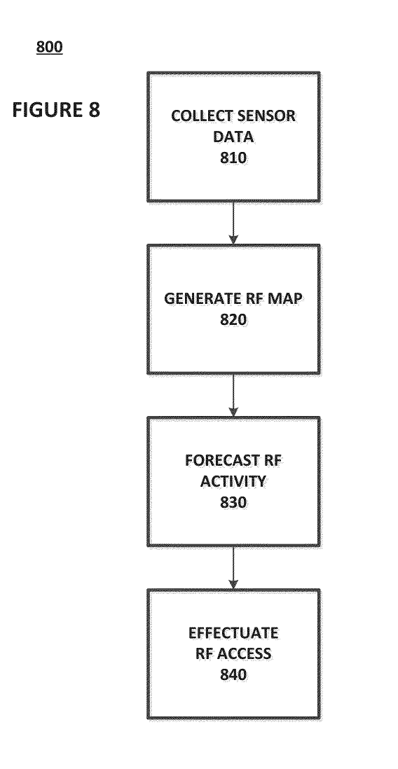

FIG. 8 is a method 800 for implementing dynamic RF mapping. In step 810 of method 800, spectrum sensor data is gathered from a spectrum sensor network. This data is used to determine the quality for various spectrum segments. Sensor data may be gathered from a sensor network like that illustrated in FIG. 1 and FIG. 7. The sensor network data may be distributed in a geographical area and used to spatially sample signal levels for utilization in future RF mapping.

In step 820, an RF map like that illustrated in FIG. 2 is generated. The RF map may be generated utilizing dynamic radio frequency mapping, which provides estimates of RF power levels over an area where spectrum activity or changes in the environment may be transient. These power levels can be used for a variety of applications such as interference management, spectrum policing, and facilitating spectrum auctions. The present methodology can quantify the effect of aliasing on the estimation of an RF map as a function of the sampling density and the number of antennas used at a sensing node.

In step 830, RF activity is forecast based on the RF map. Forecast activity may occur using historical measurements and correlation with major events in a geographical area. Other considerations may be taken into account including seasonal considerations. Utilizing current and historical RF maps, future RF activity may be forecast using anticipated usage patterns. In some instances, the prediction of future RF activity may be provided to effectuate network access as discussed in step 840 below. The prediction of future RF activity may also be used in conjunction with a planning engine to estimate future network resource needs. The prediction of future network activity or, in some instances, real time network activity may also be used in conjunction with a spectrum alert engine to generate activity alerts.

In step 840, RF access is effectuated in light of information generated through dynamic RF mapping, including activity forecasts like those in step 830. RF access may be implemented through one or more policies. Policies may be derived through execution of a priority or economic policy engine (not shown). Policies may include one or more of a priority policy such as emergency or military needs as well as economic parameters such as spectrum bidding. Policy application and RF access may also take into account a combination of such factors whereby an economic policy such as a winning spectrum bid is trumped by an unplanned emergency event.

In any event, execution of a policy and effectuation of network access may result in the assignment of specific radio resources or wireless service providers. A spectrum resource assignment decision may be provided to radio infrastructure equipment and related providers to allow for spectrum access subject to any limitations or requirements of an aforementioned policy.

One skilled in the art will appreciate the reference to various APIs, engines, instructions, or other executable components as described above. One skilled in the art will likewise appreciate that these various functionalities or methodologies may be implemented in the context of computer-readable instructions. Those instructions may be stored in a non-transitory computer readable storage medium such as memory. Those instructions may be executed by a processor or series of processing devices which may be local or distributed; the same may be said of the storage of said instructions. Various other computer and networking components will be known to one of skill in the art for the purpose of receiving and transmitting those instructions, storing said instructions, and otherwise effectuating the same.

The foregoing detailed description has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A system for dynamic RF mapping, the system comprising:
a plurality of network sensors that gather data concerning RF signal power in a segment of spectrum in the RF spectrum;
memory storing non-transitory computer readable instructions executable by a processor to:
process data gathered from the plurality of network sensors to identify the quality for one or more spectrum segments in the RF spectrum,
map the quality of the RF spectrum, and
forecast further spectrum activity based on the mapped quality of the RF spectrum; and
a spectrum manager that allows for spectrum access and use by way of radio infrastructure equipment, the spectrum manager responsive the forecast of further spectrum activity.
